(19) United States
(12) Patent Application Publication
(10) Pub. No.: US 2016/0077831 A1
(43) Pub. Date: Mar. 17, 2016

(54) ACCURATE AND PERFORMANT CODE DESIGN USING MEMOIZATION

(71) Applicant: Microsoft Corporation, Redmond, WA (US)

(72) Inventors: Bogdan Ionut Mihalcea, Bothell, WA (US); Jason T. Barnett, Renton, WA (US); Pete Steijn, Kirkland, WA (US)

(21) Appl. No.: 14/486,851

(22) Filed: Sep. 15, 2014

(51) Int. Cl. G06F 9/44

(52) U.S. Cl. CPC G06F 8/75

(57) ABSTRACT

Methods, systems, and computer program products are provided that enable intelligent assistance functions to be performed on program code over multiple contexts associated with the program code. An intelligent assistance function may be performed on the program code for a first context associated with the program code to generate results for the first context that do not cover all of the program code. The intelligent assistance function is iterated for one or more additional contexts associated with the program code, with each iteration being performed on portions of the program code that were not able to be analyzed under the prior context iterations, until the program code is covered in its entirety. In this manner, results may be generated for the entirety of the program code that cover all of the associated contexts.

### BACKGROUND

Various types of development applications exist that software developers may use to develop software. An integrated development environment (IDE) is a type of software development application that contains several development tools in one package. An IDE may include tools such as a source code editor, a build automation tool, and a debugger. Examples of IDEs include Eclipse™ developed by Eclipse Foundation of Ottawa, Canada, ActiveState Komodo™ developed by ActiveState of Vancouver, Canada, IntelliJ IDEA developed by JetBrains of the Czech Republic, Oracle JDeveloper™ developed by Oracle Corporation of Redwood City, Calif., NetBeans developed by Oracle Corporation, Codenvy™ developed by Codenvy of San Francisco, Calif., Xcode® developed by Apple Corporation of Cupertino, Calif., and Microsoft® Visual Studio®, developed by Microsoft Corporation of Redmond, Wash.

Conventional software development applications typically provide intelligent assistance to developers writing code. This helps the developers write their code in a faster, more efficient manner. Such intelligent assistance may be provided in various ways. For instance, software development tools may include functionality that presents lists of possible code “completions” referred to as “autocompletion,” lists of valid members of a type, information about parameters required by a method, and further types of assistance. In one example, Microsoft® Visual Studio® a tool referred to as IntelliSense® that implements functions such as these. At the time such intelligent assistance is provided, the program code typically has to be analyzed across its entirety.

A context of a program code indicates attributes that apply to the program code, such as a phase of development (e.g., debug, release, etc.) or an operating system that the program code is directed to. Information about the context of program code may be used by a compiler to compile the program code to its target systems/devices properly.

A development application may enable a developer to develop program code directed to more than one context. For instance, a developer may develop program code to be directed to multiple operating systems (OS), such as Microsoft Windows®, Apple iOS™, and/or Google Android™.

It is noted that a context may be selected to be considered to be the “active context.” For example, a particular OS that is currently selected (e.g., Microsoft Windows®) of several OSs that the program code is directed to may be considered to be the active context OS for the program code. When an intelligent assistance function is performed on the program code, the function is performed with respect to the active context. In other words, the function is performed on the entirety of the program code to generate information just for that active context program code. Information is not generated for program code for other contexts. To obtain intelligent assistance information with respect to a different OS, for example, that different OS has to be made the active context OS, and the intelligent assistance function has to run again over the program code with that new active context setting.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that enable intelligent assistance functions to be performed on program code over multiple contexts associated with the program code. An intelligent assistance function may be performed on the program code for a first context associated with the program code to generate results for the first context that do not cover all of the program code. The intelligent assistance function is iterated for one or more additional contexts associated with the program code, with each iteration being performed on the portion of the program code for which results were not generated under prior iterations, until results are generated that cover the program code in its entirety. In this manner, all of the contexts associated with the program code are covered.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a computing device that includes a code development system that enables an intelligent assistance function to be performed on program code for multiple contexts, according to an example embodiment.

FIG. 2 shows a flowchart providing a process for responding to a request for an intelligent assistance function to be performed on program code, according to an example embodiment.

FIG. 3 shows a flowchart providing a process for an intelligent assistance function to be performed on program code for multiple contexts, according to an example embodiment.

FIG. 4 shows a flowchart for using conditional compilation indicators for determining portions of program code that can or cannot be analyzed for a particular context, according to an example embodiment.

FIG. 5 shows a flowchart providing a process for performing an iteration of an intelligent assistance function on program code, according to an example embodiment.

FIG. 6 shows a block diagram of a multi-context assistance iterator, according to an example embodiment.

FIG. 7 shows a flowchart providing a process that may be performed for the multi-context assistance iterator of FIG. 6 to iteratively perform an intelligent assistance function on program code over multiple contexts, according to an example embodiment.

FIG. 8 shows a block diagram of an exemplary user device in which embodiments may be implemented.

FIG. 9 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments for Multi-Context Intelligent Assistance

Embodiments described herein enable intelligent assistance analysis to be performed on program code over multiple contexts. Some software development applications provide intelligent assistance to developers (persons who design program code). Examples of such intelligent assistant functions include autocompletion that presents lists of possible code “completions”, providing a list of valid members of a type, providing information about parameters required by a method, providing assistance with rename refactoring, and further types of assistance. These and/or other intelligent assistance functions are enabled to be performed over multiple contexts associated with program code under development.

A context of a program code is defined by one or more development-related attributes that apply to the program code, including a development configuration for the program code (also referred to as development phase or stage) such as debug or release, a platform for the program code (e.g., an instruction set, operating system, operating system version, hardware platform (e.g., chipset), etc.), a software project associated with the program code, etc. One or more of such attributes may be referred to as a context for the program code. Context for a program code may include any number of attributes, and may be expressed in any manner, such as [development phase/platform/project] in the example where there are three attributes, and where “development phase” is the development phase context (e.g., debug, release, etc.), “platform” is the platform context (e.g., win32, win64, iOS, Android, x86, x64, ARM, ia64, etc.), and “project” is the software project context.

With respect to “project”, a code file (e.g., a .cpp file for C++ program code) may be configurable to operate differently in different project contexts. For example, a project1 may be defined by executing a “a .cpp” program file. A project2 may be defined by executing the same “a .cpp” program file with the addition of a command line switch that causes “a .cpp” to operate differently than without the switch (e.g., the command line execution of “a .cpp /D FOO” may cause all of the “#ifdef FOO” code blocks in a .cpp to be enabled, whereas, by executing “a .cpp” without the “/D FOO” switch may cause any “#ifdef FOO” blocks in a .cpp to not be enabled).

A development application may enable a developer to develop program code directed to more than one context. For instance, a first context associated with a program code may be [Debug/win32/project1], where “Debug” is the development phase, “win32” is the platform, and “project1” is the identifier for the particular software project. A second context associated with the program code may be [Release/win32/project2], etc. Program code may have an “active context,” which includes a combination of context attributes that are selected. A compiler may use the active context to configure the type of compilation to be performed on the program code.

To enable the program code to be directed to multiple OSs, some of the program code may be designed using code statements that apply to all of the target OSs, and other portions of the program code may be designed with code statements that only apply to a specific OS (when needed due to differences in the OSs). The program code may include markings or other indications (“conditional compilation indicators”) for the portions of the program code that do not apply to all OSs so that those portions can be conditionally compiled. Embodiments enable intelligent assistance to be performed on program code marked in this manner, or having different contexts indicated in any other manner, across any number of contexts associated with the program code, in an automatic manner.

As such, in embodiments, the developer does not have to individually set each context active and execute the intelligent assistance over the active contexts one by one to obtain results over all contexts. Instead, the intelligent assistance may be invoked once for the active context, and the intelligent assistance is automatically performed in a manner that covers all contexts.

Determining knowledge using intelligent assistant for each context individually, as in conventional techniques, is expensive. If each context attribute is considered to be a dimension of a context matrix (e.g., a “cube” when 3 dimensions/attributes are present), the total number of contexts that would need to be run over would be the numbers of members of each context attribute multiplied by each other. For instance, if there are two development phases, five platforms, and three projects in a particular example context matrix for program code, the total number of possible contexts for the context matrix is 2×5×3=30 contexts. 30 context is a large number of context to individually execute an intelligent assistance function over. Considering that the matrix of contexts will likely be growing, the problem will become more severe.

Accordingly, embodiments enable multi-context intelligent assistance to be performed. This aids developers, who desire to know the impact of shared code changes in all contexts immediately (e.g., displayed as squiggles in the code editor, for example).

Performance is a key limiter to providing a high quality intelligent assistance experience for functions such as “Refactor Rename” for C++ developers across all combinations of configurations, platforms, and projects and/or other contexts. By intelligently re-processing the inputs for contexts further to the active context only when the initial processing results for the active context do not fully resolve all candidate locations, you can turn the experience described above (e.g., where there are 30 or other high number of contexts) from an exponential experience to a smaller scale operation for typical real world code scenarios. For instance, only a few context may need to be processed to generate results that cover all contexts.

For example, with respect to rename refactoring, all the candidates (textual) may be collected from a preprocess database, and grouped and processed by input file starting with a first context (e.g., debug/win32/project1. As long as there are unresolved candidates in this file, the input file may be processed using a second context, a third context, a fourth context, and so on. Intelligent assistance process may stop when the input file is processed in its entirety, which may be prior to using all possible contexts.

In an embodiment, a developer or automatic algorithm may intelligently select a subset of the total group of possible contexts to use to perform intelligent assistance over program code in a manner that improves performance.

Numerous exemplary embodiments for multi-context intelligent assistance are described in the following subsections.

A. Example Development System Embodiments for Multi-Context Intelligent Assistance

Development systems may be configured in various ways to enable multi-context intelligent assistance for program code, in embodiments. For instance, FIG. 1 shows a block diagram of a development system 100, according to an example embodiment. As shown in FIG. 1, development system 100 includes a source code editor 102, a compiler 104, a debugger tool 106, a multi-context assistance iterator 108, and storage 110. Note development system 100 is provided for illustrative purposes, and as an example embodiment, and that not all features of development system 100 need to be present in all embodiments (e.g., debugger tool 106 need not be present in all embodiments). Furthermore, additional features not shown in FIG. 1 may be present in some embodiments. The features of system 100 shown in FIG. 1 are described as follows.

As shown in FIG. 1, development system 100 may be implemented in one or more computing devices 118. For instance, source code editor 102, compiler 104, debugger tool 106, and multi-context assistance iterator 108 may be included in a same computing device, or one or more of source code editor 102, compiler 104, debugger tool 106, and multi-context assistance iterator 108 may be implemented in or more computing devices separate from those of others of source code editor 102, compiler 104, debugger tool 106, and multi-context assistance iterator 108.

Computing device(s) 118 may be any type of stationary or mobile computing device(s), including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer).

A developer may interact with source code editor 102 to enter and modify program code when generating source code for an application. For instance, the developer may interact with a user interface 112 of code editor 102 to add, modify, or delete program code text such as by typing, by voice input, by selecting suggested code blocks, etc. Accordingly, user interface 112 may include one or more text entry boxes/windows, voice/speech recognition, one or more graphical user interface elements (e.g., buttons, check boxes, radio buttons, pull down menus, etc.), and/or other user interface elements that a developer may interact with. When complete, or at other intervals, the user may be enabled to save the program code by interacting with a “save” button or other user interface element. Source code editor 102 may be a browser based editor, a code editor integrated in a desktop or mobile application, or any other type of code editor.

For instance, as shown in FIG. 1, a developer may interact with user interface 112 of source code editor 102 to generate program code 114. Program code 114 is source code, which is a collection of computer instructions (possibly with comments) written using a human-readable computer programming language. Examples of suitable human-readable computer programming languages include C, C++, Java, etc. Program code 114 may be received in one or more files or other form. For instance, program code 114 may be received as one or more “.c” files (when the C programming language is used), as one or more “.cpp” files (when the C++ programming language is used), etc. As shown in FIG. 1, program code 114 may be stored in storage 110. Storage 110 may include one or more of any type of physical storage hardware/circuitry to store data, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of physical storage hardware/circuitry.

Note that program code 114 may include code statements and/or marked code put into program code 114 as debug code for purposes of debugging (e.g., break points, display of register values, comments, etc.).

Compiler 104 may be invoked in any manner, such as by a command line, a graphical user interface, etc. A “-full” switch, or other switch, may be used when compiler 104 is invoked to perform a full compile. Compiler 104 is configured to receive and compile program code 114 to generate machine code 122. In particular, compiler 104 is configured to transform program code 114 into machine code 122 in the form of another computer language, typically having a binary form, referred to as machine code or object code. In some cases, compiler 104 may include multiple stages, and may first convert program code 114 into an intermediate form (e.g., an intermediate language), which is subsequently converted into machine code 122.

Compiler 104 may be configured to perform one or more types of optimizations on program code 114 when generating machine code 122. An optimized build results in machine code that is semantically equivalent to machine code generated without optimizations, but is configured in a way that fewer resources are used during execution of the optimized machine code (e.g., less memory, fewer procedure calls, etc.). Examples of optimizations that may be performed include loop optimizations, data-flow optimizations, SSA-based optimizations, code-generator optimizations, functional language optimizations, interprocedural optimizations, and/or further types of optimizations that would be known to persons skilled in the relevant art(s). Many specific types of optimizations exist. For example, “inlining” may be performed, where a callee function called by a caller function is copied into the body of the caller function. In another example of a specific optimization, “common subexpression elimination” may be performed, where a single instance of code is used for a quantity that is computed multiple times in source code.

Machine code 122 may be included in a file (e.g., an object or “.obj” file), or may be created/stored in another form, to form an executable program or application. Machine code 122 may optionally be stored in storage 110.

When program code 114 is compiled by compiler 104 for the debug stage of development, debugger tool 106 may receive machine code 122. Debugger tool 106 is configured to run a debugger (or “debug”, “debugging”) session on the application represented by machine code 122. In a debugger session, a developer may be enabled to step through the execution of code of machine code 122, while viewing the values of variables, arrays, attributes, and/or outputs (e.g., contents of registers, a GUI, etc.) generated by the execution of machine code 122, including having access to the effects of any debug code/statements entered into program code 114 (and passed to machine code 122 by compiler 104 for purposes of debug). In this manner, a developer may be able to test or troubleshoot (“debug”) program code 114, making edits to program code 114 using code editor 102 based on the results of the debugger session. The modified version of program code 114 may be compiled by compiler 104 and received by debugger tool 106 for further debugging. Debugger tool 106 may include one or more processors (e.g., a central processing unit (CPU)), physical and/or virtual, that execute(s) machine code 122.

When debugging by debugger tool 106 is complete, and program code 114 is in its final version, compiler 104 may compile program code 114 to generate machine code 122 for the release stage of development. The release version of machine code 122 may be released to be used by users. Note that when compiling program code 114 to generate machine code 122 for release, any statements in program code 114 marked as debug statements are ignored (are not compiled so that their compiled versions are not present in machine code 122).

As described above, a developer may design program code 114 to be directed to multiple contexts, including multiple development stages (e.g., debug, release), multiple platforms, multiple projects, etc. For example, code editor 102 may enable the developer to mark one or more portions of program code 114 as being directed to specific contexts (e.g., a specific development stage, a particular operating system and version, etc.). Such code portions may be marked or indicated in any manner, such as through the use of a conditional compilation indicator (e.g., an “ifdef” directive, etc.) or in another manner. Any form of conditional compilation indicators may be present, including special characters, tags, code directives, and/or forms. As such, source code editor 102 may generate program code 114 to indicate one or more functions, methods, and/or other code portions to compile conditionally for particular contexts.

For example, program code 114 may be code for an application that the developer wants to run on multiple platforms, including a first device that executes a version of the Microsoft Windows® operating system (OS), a second device that executes a version of Apple iOS™, and a third device that executes a version of the Google Android™ operating system. Accordingly, code editor 102 may enable the developer to generate program code 114 so that it can be compiled into machine code suitable for each of the OSs. One portion of program code 114 may be written such that it can be compiled into machine code suitable for all of the OSs, while other portions of program code 114 may be written to be compiled into machine code suitable for fewer than all of the OSs. For instance, a first chunk of code in program code 114 may be applicable to all OSs, a second chunk of code in program code 114 may be marked as directed to Apple iOS™ (but not for Microsoft Windows® or Google Android™), and a third chunk of code in program code 114 may be marked as directed to Microsoft Windows® (but not for Apple iOS™ or Google Android™).

The following is exemplary pseudo code (for the C++ programming language) that may be included in program code 114. This example illustrates use of the “ifdef” directive for conditional compilation based on operating system type:

```
#ifdef_WIN32
    print(“windows”);
#elif defined_UNIX_{—}
    print(“UNIX”);
#endif
```

According to the above pseudo code, if an instance of compiler 104 defines the macro “_WIN32”, the compiler instance generates machine code 122 that targets Microsoft Windows®, and would compile the print (“windows”) statement of the ifdef body. The compiler instance would not compile the print (“UNIX”) statement, which is directed to the UNIX operating system. Alternatively, if another instance of compiler 104 defines the macro “_UNIX_”, the compiler instance generates machine code 122 that targets the UNIX operating system, and would compile the print (“UNIX”) statement of the elif (else-if) body. That compiler instance would not compile the print (“windows”) statement, which is directed to the Microsoft Windows® operating system. The above exemplary conditionally compiled code segment is terminated by the endif statement.

Conditional compilation indicators can be used in similar fashion to direct code to other contexts, including a code development stage (e.g., debug or release), other platform type, software project, etc.

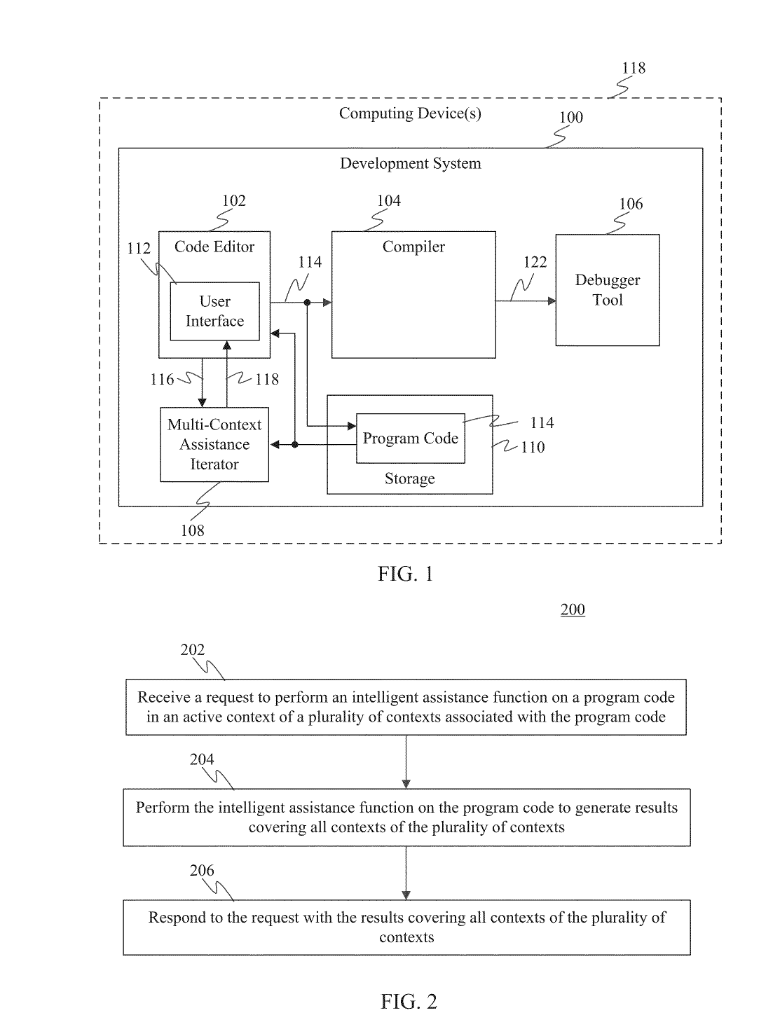

Multi-context assistance iterator 108 is configured to perform intelligent assistance with respect to code design/code development. Furthermore, according to the embodiments described herein, multi-context assistance iterator 108 enables intelligent assistance to be automatically provided for multiple contexts associated with the code under development. For instance, in an embodiment, multi-context assistance iterator 108 may operate according to FIG. 2. FIG. 2 shows a flowchart 200 providing a process for responding to a request (also referred to as a “query”) for an intelligent assistance function to be performed on program code, according to an example embodiment. Flowchart 200 is described as follows with respect to FIG. 1. Further structural and operational embodiments will be apparent to persons skilled in the relevant art(s) based on the following description.

Flowchart 200 begins with step 202. In step 202, a request is received to perform an intelligent assistance function on a program code in an active context of a plurality of contexts associated with the program code. For example, as shown in FIG. 1, a request 116 may be received from code editor 102. Request 116 is a request to perform one or more intelligent assistance functions on program code 114. Program code 114 may have an active context selected prior to or in conjunction with receiving request 116. In one embodiment, request 116 may be generated based on a user interaction with user interface 112. For instance, a developer may click on or touch a button, make a menu selection, voice a command, or otherwise interact with user interface 112 to cause request 116 to be issued. The developer may select a particular intelligent assistance function to be performed, such as a term search (e.g., search for all instances of a term such as “size” in program code 114), a search and replace function, a rename refactoring function, autocompletion, and/or any other intelligent analysis function disclosed elsewhere herein or otherwise known. The selected intelligent assistance function(s) is/are specified in request 116.

In another embodiment, request 116 may be generated automatically by code editor 102. For instance, code editor 102 may generate request 116 automatically in response to code that the developer has recently entered into user interface. For example, the developer may enter at least a portion of a particular function, and code editor 102 may automatically generate request 116 to suggest autocompletion text to the developer, and/or to perform other intelligent assistance function with respect to the function.

In step 204, the intelligent assistance function is performed on the program code to generate results covering all contexts of the plurality of contexts. As shown in FIG. 1, multi-context assistance iterator 108 receives request 116. In an embodiment, in response to receiving request 116, multi-context assistance iterator 108 retrieves or otherwise accesses program code 114, and is configured to perform the requested intelligent assistance function on program code 114. Multi-context assistance iterator 108 may be configured to perform any one or more intelligent assistance functions in response to request 116. Furthermore, multi-context assistance iterator 108 is configured to perform the one or more intelligent assistance functions such that they cover all contexts associated with program code 114. For example, multi-context assistance iterator 108 may be configured to iterate the one or more intelligent assistance functions across one or more of the contexts associated with program code 114, performing the intelligent assistance function(s) on a first (active) context, then a second context (if needed), then a third context (if needed), etc., until all contexts associated with program code 114 are covered such that program code 114 has been processed for intelligent assistance in its entirety. Note that iterating the intelligent assistance function(s) over less than all contexts may still generate results that cover all contexts.

In step 206, the request is responded to with the results covering all contexts of the plurality of contexts. As shown in FIG. 1, multi-context assistance iterator 108 generates results 118. Results 118 includes results generated from the one or more intelligent assistance functions that cover all of the contexts associated with program code 114. User interface 112 receives results 118, and displays results 118 with respect to program code 114. For example, results 118 may be displayed in user interface 112 next to, overlaid on, or in other relationship with respect to program code 114. The results for all contexts may be displayed simultaneously, or the developer may be enable to interact with user interface 112 to cause results for each context to be displayed one at a time (e.g., may step through display of the results for different contexts one-by-one by clicking the mouse or on a key, etc.).

Multi-context assistance iterator 108 may be configured to operate in various ways, and may have various structures to perform its functions, in embodiments. The following subsections describe exemplary embodiments for the operation of, and for structures of, multi-context assistance iterator 108.

1. Example Embodiments for Multi-Context Intelligent Assistance Iteration

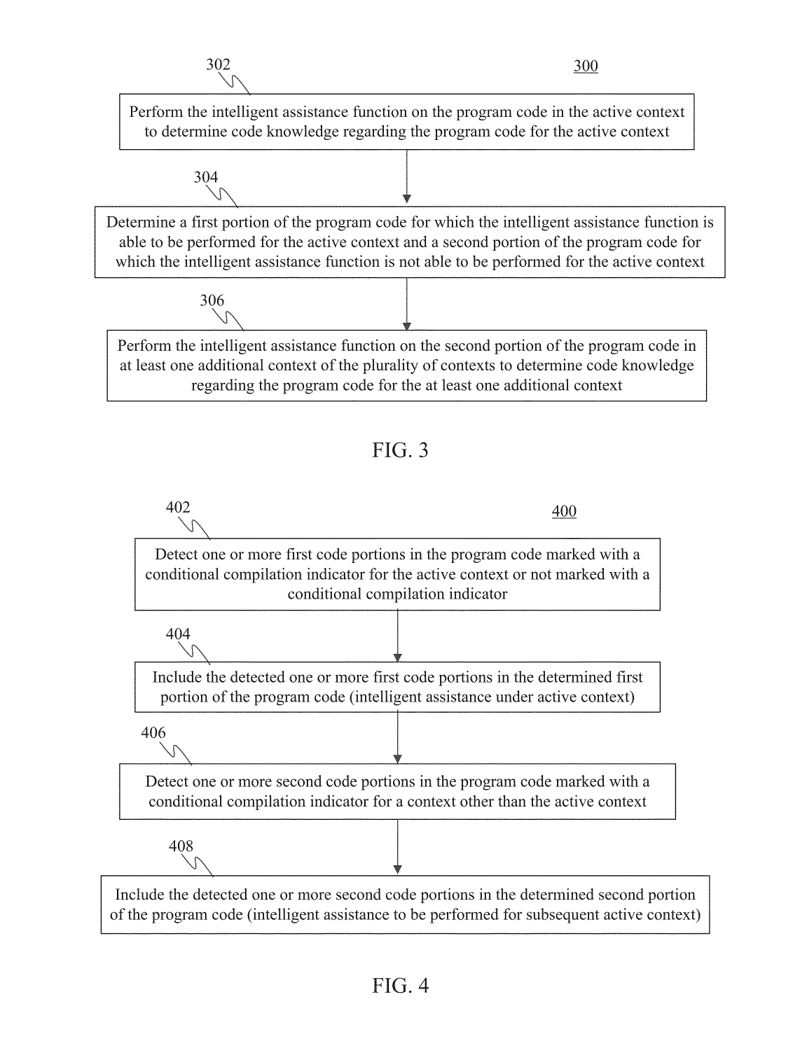

As described above, flowchart 200 of FIG. 2 provides an example process for responding to a request for an intelligent assistance function. Note that step 204 of flowchart 200 may be performed in various ways so that results are generated for an intelligent assistance function that covers all contexts. For instance, FIG. 3 shows a flowchart 300 providing a process for an intelligent assistance function to be performed on program code for multiple contexts, according to an example embodiment. In an embodiment, multi-context assistance iterator 108 of FIG. 1 may operate according to flowchart 300. Flowchart 300 is described as follows with respect to FIG. 1. Further structural and operational embodiments will be apparent to persons skilled in the relevant art(s) based on the following description.

Flowchart 300 of FIG. 3 begins with step 302. In step 302, the intelligent assistance function is performed on the program code in the active context to determine code knowledge regarding the program code for the active context. In an embodiment, multi-context assistance iterator 108 of FIG. 1 is configured to perform the intelligent assistance function(s) (e.g., indicated in request 116) on program code 114. Performing an intelligent assistance function on program code 114 generates knowledge regarding program code 114, as pertains to the particular function performed, and that code knowledge is included in results 118.

For instance, with respect to autocompletion as the intelligent assistance function, the code knowledge that is generated based on analysis of program code 114 may include one or more possible code completions for the program code that a developer enters into code editor 102. For instance, a pop-up list of possible completions for the current input prefix may be provided in the results (based on similar instances of the input prefix elsewhere in program code 114), such as providing the complete name of a variable or method, the members of a particular class, the attributes of a particular function, etc. With respect to a searching or browsing function, a search may be performed on a term (e.g., “size”), and a location of all of the instances of the term in the file(s) of program code 114 may be returned in the results as code knowledge. With respect to a rename refactoring function, identifiers for code symbols such as fields, local variables, methods, namespaces, properties, and types may be renamed. Rename refactoring can be used to change the names in comments and in strings and to change the declarations and calls of an identifier. As such, when a rename refactoring function is performed on a term by a developer, a location of all of the instances of the term in the file(s) of program code 114 may be returned in the results as code knowledge, and the term can easily be renamed. In a similar manner, code knowledge may be returned by multi-context assistance iterator 108 in results 118 for other types of intelligent assistance functions mentioned elsewhere herein or otherwise known, as would be known to persons skilled in the relevant art(s) from the teachings herein.

In an embodiment, multi-context assistance iterator 108 performs the intelligent assistance function(s) on an active context of program code 114. For example, in an embodiment, an active context for program code 114 may be set. The active context may have been selected by a developer interacting with user interface 112 (e.g., by clicking on or touching a box, using a pull down menu, entering a command line switch, etc.), or may be automatically determined by code editor 102 (e.g., by reading metadata associated with program code 114, reading header information of a file of program code 114, etc.). As described above, an active context indicates a combination of context attributes that are selected for program code 114. For instance, the active context may indicate a development stage, a platform, a project, and/or further information regarding program code 114. During compilation of program code 114, compiler 104 may use the active context to configure the type of compilation to be performed. Furthermore, multi-context assistance iterator 108 may use the active context as the first context for the intelligent assistance function.

As such, in step 302, the intelligent assistance function is performed on the portion of program code 114 determined to be in the active context. This portion of program code 114 may be determined in various ways, including as described below with respect to FIG. 4.

In step 304, a first portion of the program code for which the intelligent assistance function is able to be performed for the active context and a second portion of the program code for which the intelligent assistance function is not able to be performed for the active context are determined Referring back to step 302, which may be performed before or after step 304, the intelligent assistance function is performed on the portion of program code 114 that pertains to the active context. The portions of program code 114 that do not pertain to the active context are determined so that subsequent iterations of the intelligent assistance function may be performed on them. Thus, in an embodiment, multi-context assistance iterator 108 is configured to analyze program code 114 to determine a first portion that pertains to the active context and a second portion that pertains to the other, non-active context(s). These first and second portions of program code 114 may be determined in various ways, including as described as follows with respect to FIG. 4.

FIG. 4 shows a flowchart 400 for using conditional compilation indicators for determining portions of program code that can or cannot be analyzed for a particular context, according to an example embodiment. In an embodiment, flowchart 400 may be performed during step 304 of FIG. 3. Flowchart 400 is described as follows with respect to FIG. 1. Further structural and operational embodiments will be apparent to persons skilled in the relevant art(s) based on the following description.

Flowchart 400 of FIG. 4 begins with step 402. In step 402, one or more first code portions in the program code are detected that are marked with a conditional compilation indicator for the active context or are not marked with a conditional compilation indicator. According to step 402, program code 114 is searched by multi-context assistance iterator 108 (FIG. 1) to determine code that can be processed by the intelligent assistance function under the current active context. Such code may be indicated in program code 114 in any manner, including by a conditional compilation indicator such as an ifdef statement, or other indicator, which indicates the code applies to the current active context. For instance, if the current active context platform is win64, and an ifdef statement indicates code in an associated code body is directed to win64, that code is detected as marked for the active context in step 402.

Furthermore, code in program code 114 that is not marked by any type of conditional compilation indicator may be assumed to be code that is directed to the current active context (as well as other contexts), and thus is detected in step 402.

In step 404, the detected one or more first code portions are included in the determined first portion of the program code. Note that program code 114 may be in the form of a single code file, or may have the form of multiple code files (including hundreds, thousands, and even greater numbers of code files), grouped as a particular software project. As such, in step 404, one or more entire code files detected in step 402 may be categorized as code over which the intelligent assistance function is/was able to be performed, and/or one or more portions of one or more code files detected in step 402 may be categorized as code over which the intelligent assistance function is/was able to be performed. For instance, one or more functions or methods in a particular code file may be detected as directed to the active context, while one or more other functions or methods in the same code file may not be directed to the active context. The functions/methods of the code file detected as directed to the active context are included in the first portion mentioned in step 304 (FIG. 3) (for which the intelligent assistance function is/was able to be performed), while the remaining functions/methods are not.

In step 406, one or more second code portions in the program code are detected that are marked with a conditional compilation indicator for a context other than the active context. According to step 406, program code 114 is searched by multi-context assistance iterator 108 (FIG. 1) to determine code that cannot be processed by the intelligent assistance function under the current active context. Such code may be indicated in program code 114 in any manner, including by a conditional compilation indicator such as an ifdef statement, or other indicator, which indicates the code applies to a context other than the current active context. For instance, if the current active context is win64, and an ifdef statement indicates code in an associated code body is directed to ia64, that code is detected as marked for a context other than the active context.

In step 408, the detected one or more second code portions are included in the determined second portion of the program code. In an embodiment, one or more entire code files detected in step 406 and/or portions of code files may be categorized as code over which the intelligent assistance function is not yet able to be performed. For instance, one or more functions or methods in a particular code file may be directed to the active context, while one or more other functions or methods in the same code file may be detected as not directed to the active context. The functions/methods of the code file detected as not being directed to the active context are included in the second portion mentioned in step 304 (FIG. 3) (for which the intelligent assistance function is not yet able to be performed).

Thus, according to flowchart 400 of FIG. 4, a first portion of program code 114 may be determined that can be processed according to the intelligent assistance function(s) of request 116 (due to being directed to the active context), and a second portion of program code 114 may be determined that cannot be processed according to the intelligent assistance function(s) of request 116 (due to not being directed to a different context than the active context). In other embodiments, the first and second portions of program code 114 may be determined in other ways, as would be apparent to persons skilled in the relevant art(s) from the teachings herein.

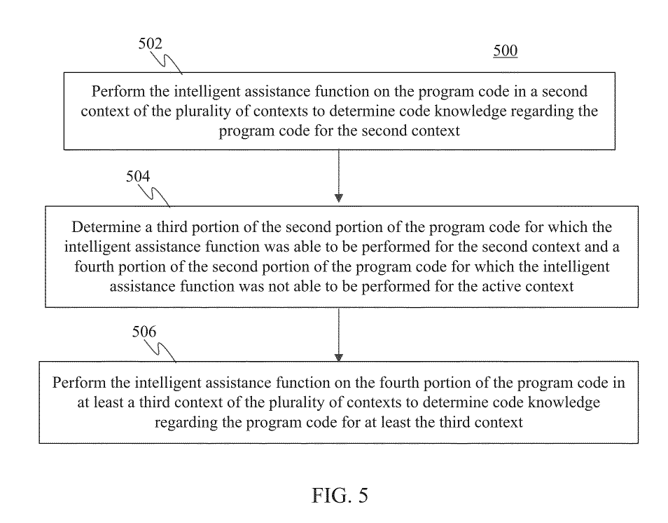

Referring back to FIG. 3, in step 306, the intelligent assistance function is performed on the second portion of the program code in at least one additional context of the plurality of contexts to determine code knowledge regarding the program code for the at least one additional context. Multi-context assistance iterator 108 is configured to iterate through one or more contexts to perform the intelligent assistance function on the second portion of program code 114 (which was not processed by the intelligent assistance function under the prior active context). For instance, multi-context assistance iterator 108 may operate according to FIG. 5. FIG. 5 shows a flowchart 500 providing a process for performing an iteration of an intelligent assistance function on program code, according to an example embodiment. In an embodiment, flowchart 500 may be performed during step 306 of FIG. 3. Flowchart 500 is described as follows with respect to FIG. 1. Further structural and operational embodiments will be apparent to persons skilled in the relevant art(s) based on the following description.

Flowchart 500 of FIG. 5 begins with step 502. In step 502, the intelligent assistance function is performed on the program code in a second context of the plurality of contexts to determine code knowledge regarding the program code for the second context. In an embodiment, in a similar fashion as in step 302 (FIG. 3), in step 502, multi-context assistance iterator 108 of FIG. 1 is configured to perform the intelligent assistance function(s) on program code 114 in a second context. In particular, the intelligent assistance functions(s) may be performed on the portions of program code 114 that were not able to be processed in the prior context iteration(s). Performing the intelligent assistance function(s) on these portions of program code 114 can generate knowledge regarding these portions of program code 114 with regard to the second context, and that code knowledge is also included in results 118 (in addition to any previously generated code knowledge generated for program code 114 in any prior iterations). Furthermore, by performing the intelligent assistance function(s) only on the portions of program code 114 that were not able to be processed under the active context, and not on portions of program code 114 that the intelligent assistance function(s) was/were performed on under the active context, processing time is saved (each program code portion is processed by the intelligent assistant function(s) once).

In an embodiment, the second context may be selected from all available contexts (that have not already been iterated) in any manner. For instance, the active context may be any context in the context matrix for program code 114 (e.g., having dimensions of development phase, platform, project, etc.). The second context may be any context other than the active context of the context matrix. For instance, the second context could be selected as the context having coordinates of 0 for each dimension of the context matrix, another coordinate value for each dimension, a random coordinate value for each dimension, or in any other manner.

Alternatively, the second context may be selected intelligently. For instance, the second context may be selected from a list of contexts provided by the user, by a smart algorithm of multi-context assistance iterator 108, or in any other intelligent manner.

As such, the second context may selected in any of these or other manners, and subsequent contexts (e.g., third context, fourth context, etc.) may be selected in a similar manner. For instance, a subsequent context may be selected by incrementing a value of one or more dimension coordinates from the prior values, by random selection from the context matrix, and/or in any other manner.

For instance, in an embodiment, the context matrix may be a cube having the three dimensions of development phase, platforms, and project. Each dimension may include a corresponding set of values. Example values for the three dimensions are shown as follows for illustrative purposes:

development phases=debug, release

platforms=win32, win64, x86, x64, ARM, ia64

projects=project1, project2, project3

In an example, the original active context (of step 302 of FIG. 3) may be the following context of [debug, x64, project3] (having matrix coordinates 0, 3, 2). In step 502, the second context may be selected in any manner, such by selecting a set of the 0 coordinate members to form [debug, win32, project3], incrementing a dimension of the active context to form [release, x64, project3] (where the development phase was incremented), by randomly selecting the coordinates to form a random combination such as [debug, ARM, project2], by making an intelligent selection (e.g., manually by the user, automatically by a selection algorithm, etc.), or in any other manner.

As such, in step 502, the intelligent assistance function is performed on the portion of program code 114 determined to be in the second context. This portion of program code 114 may be determined in various ways, including being determined as described above with respect to step 402 of FIG. 4 (where the second context is used in place of the active context, and only portions of program code 114 not processed in a prior iteration are analyzed for conditional compilation indicators).

In step 504, a third portion of the second portion of the program code is determined for which the intelligent assistance function was able to be performed for the second context and a fourth portion of the second portion of the program code for which the intelligent assistance function was not able to be performed for the active context. In an embodiment, if the portion of program code 114 not processed under the active context is not entirely processed under the second context, it may be desired to perform another iteration using at least a third context. The iteration using the third context may be performed on a portion of the second portion of program code 114 that was not able to be processed in step 502. Accordingly, in step 504, a (third) portion of the second portion of program code 114 for which the intelligent assistance function was able to be performed under the second context may be determined, and more importantly, a (fourth) portion of the second portion of program code for which the intelligent assistance function was not able to be performed for the second context may be determined. This determination may be made in a similar manner as in flowchart 400 of FIG. 4. For instance, conditional compilation indicators that identify code associated with the second context may be searched for, indicating the third portion of program code 114, and the remaining portions of program code 114 (not processed under the active and second contexts) may be considered the fourth portion of program code 114.

In step 506, the intelligent assistance function is performed on the fourth portion of the program code in at least a third context of the plurality of contexts to determine code knowledge regarding the program code for at least the third context. In an similar manner as described above for step 502, in step 506, multi-context assistance iterator 108 of FIG. 1 is configured to perform the intelligent assistance function(s) on program code 114 in a third context. In particular, the intelligent assistance functions(s) may be performed on the portions of program code 114 that were not able to be processed in the prior context iteration(s) (original active and second contexts). Performing the intelligent assistance function(s) on these portions of program code 114 can generate knowledge regarding these portions of program code 114 with regard to the third context, and that code knowledge is also included in results 118 (in addition to any previously generated code knowledge generated for program code 114 in any prior iterations). Furthermore, by performing the intelligent assistance function(s) only on the portions of program code 114 that were not able to be processed under the active and second contexts, and not on portions of program code 114 that the intelligent assistance function(s) were performed on under the active and second contexts, processing time is saved.

For example, in some situations, each program code portion may be processed by the intelligent assistant function(s) once, which saves processing time. In other embodiments, some program code portions may be processed in multiple iterations. Example program code is shown below to illustrate this situation:

```
<portion #1>
#ifdef DEBUG
    struct A {
        <portion #2>
#else
    struct B {
        <portion #3>
#endif
int val;
};
```

This example code is an “ifdef” directive for conditional compilation, as described elsewhere herein. Thus, in this portion of program code, portions #1 and #3 may be processed for a DEBUG context. When portion #2 is processed in a first non-debug context, portion #3 will again be processed, taking into account the knowledge built up from processing portion #2 previously. Code portion #3 is processed in both contexts (debug and non-debug) because two distinct types (“struct A” and “struct B”) are evaluated in the program code for the two contexts.

In an embodiment, the third context may be selected from all available, un-iterated contexts in any manner, including as described above with respect to selecting the second context. As such, in step 506, the intelligent assistance function is performed on the portion of program code 114 determined to be in the third context. This portion of program code 114 may be determined in various ways, including being determined in a similar manner as described above with respect to step 502 for the second context. If this third iteration does not cover all of program code 114, iterations of flowchart 500 may continue for subsequent contexts until all of program code 114 is processed with the intelligent assistance function(s). By executing the intelligent assistance function(s) in this iterative manner, each context iteration may operate on a smaller portion of program code 114, increasing speed and shortening processing time relative to techniques where the entirety of program code 114 is processed for every context. Furthermore, every possible context does not need to be iterated. In most cases, a subset of contexts may be iterated that covers all contexts.

2. Example Embodiments for a Multi-Context Assistance Iterator

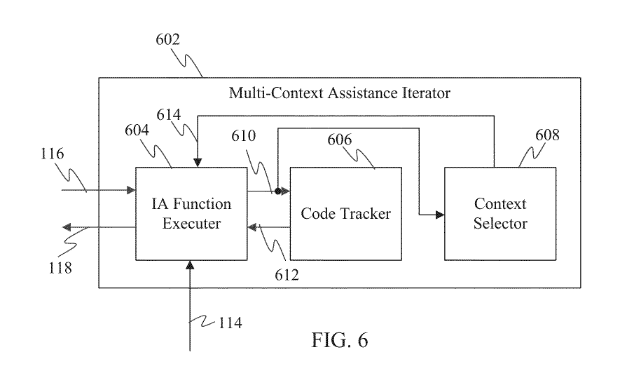

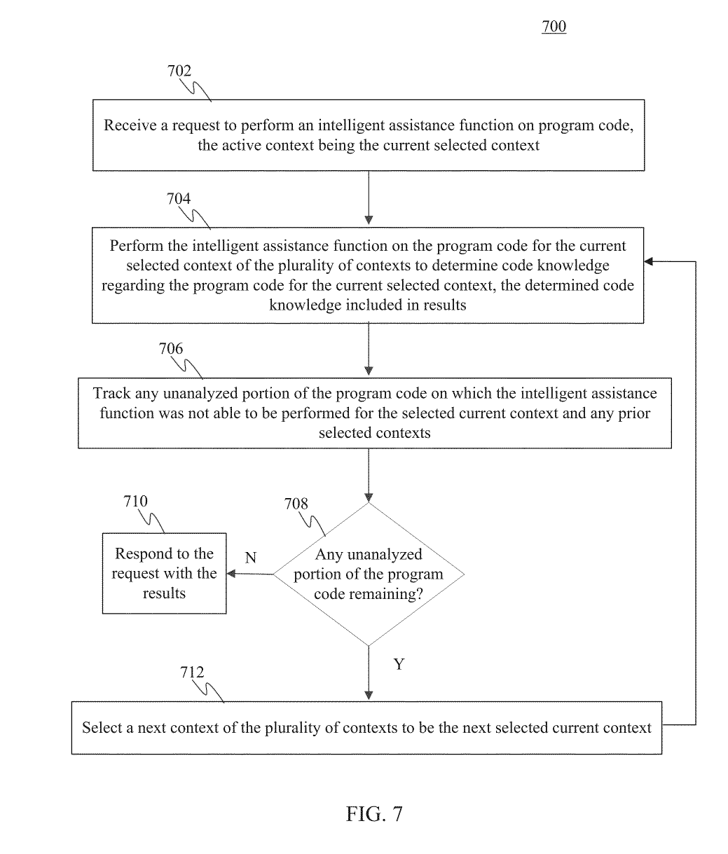

Multi-context assistance iterator 108 of FIG. 1 may be configured in various ways to enable multi-context intelligent assistance for program code, in embodiments. For instance, FIG. 6 shows a block diagram of a multi-context assistance iterator 602, according to an example embodiment. Multi-context assistance iterator 602 is an example of multi-context assistance iterator 108 of FIG. 1. As shown in FIG. 6, multi-context assistance iterator 602 includes an intelligent assistance (IA) function executer 604, a code tracker 606, and a context selector 608. Multi-context assistance iterator 602 is described as follows with respect to FIG. 7. FIG. 7 shows a flowchart 700 providing a process that may be performed by multi-context assistance iterator of FIG. 6, according to an example embodiment. Flowchart 700 is described as follows with respect to FIGS. 1 and 6. Further structural and operational embodiments will be apparent to persons skilled in the relevant art(s) based on the following description.

Flowchart 700 of FIG. 7 begins with step 702. In step 702, a request is received to perform an intelligent assistance function on program code, the active context being the current selected context. For example, as shown in FIG. 6, IA function executer 604 receives request 116. As described above, request 116 is a request to perform one or more intelligent assistance functions on program code 114. An active context may be set for program code 114 prior to or when request 116 is received. Operation proceeds from step 702 to step 704.

In step 704, the intelligent assistance function is performed on the program code for the current selected context of the plurality of contexts to determine code knowledge regarding the program code for the current selected context, the determined code knowledge included in results. As shown in FIG. 6, IA function executer 604 receives program code 114. IA function executer 604 is configured to perform the intelligent assistance function(s) indicated in request 116 on program code 114 for the current selected context, which is initially the active context, and which may be a subsequent context during a subsequent iteration. Examples of intelligent assistance functions that IA function executer 604 may perform on program code 114 are described elsewhere herein, including with respect to step 302 of FIG. 3. IA function executer 604 is configured to accumulate the results of each iteration of the intelligent assistance function performed on program code 114.

It is noted that during the first iteration, where the current selected context is the initial active context, IA function executer 604 attempts to perform the intelligent assistance function(s) on all of program code 114 in the active context. In each subsequent iteration, the current selected context is changed to a subsequent context, and IA function executer 604 may perform the intelligent assistance function(s) on a smaller portion of program code 114, which is indicated to IA function executer 604 by code tracker 606 in unanalyzed code portion 612. During step 704, IA function executer 604 may determine any portions of program code 114 on which the intelligent assistance function(s) cannot be performed in the current selected context. Operation proceeds from step 704 to step 706.

In step 706, any unanalyzed portion of the program code on which the intelligent assistance function was not able to be performed is tracked for the selected current context and any prior selected contexts. In an embodiment, IA function executer 604 outputs unanalyzed code portion 610, which indicates any portion of program code 114 that was not able to be analyzed in the last iteration (or prior iterations) of the intelligent assistance function(s) in step 704. Code tracker 606 receives unanalyzed code portion 610, and tracks this unanalyzed code, to be provided to IA function executer 604 for a subsequent iteration of step 704 in unanalyzed code portion 612.

In step 708, whether any unanalyzed portions of the program code remain is determined. In an embodiment, when unanalyzed code portion 610 is empty (no code indicated) after steps 704 and 706, no code remains that has not had the intelligent assistance function(s) performed thereon. Code tracker 606 provides the empty unanalyzed code portion 610 to IA function executer 604, which indicates the results are complete. In such case, operation proceeds from step 708 to step 710. If unanalyzed code portion 610 is not empty (unanalyzed code is indicated), the indicated code has not had the intelligent assistance function(s) performed thereon, and another iteration is desired. Accordingly, in such case, operation proceeds from step 708 to step 712.

In step 710, the request is responded to with the results. In an embodiment, when unanalyzed code portion 610 is empty, this indicates that no further code of program code 114 is present on which the intelligent assistance function(s) is to be performed. Accordingly, the accumulated results of the iterations of the intelligent assistance function on program code 114 are output as results 118 by IA function executor 604. As described above, results 118 may be received by code editor 102 (FIG. 1), and presented to the developer by user interface 112.

In step 712, a next context of the plurality of contexts is selected to be the next selected current context. For example, as shown in FIG. 6, context selector 608 may receive unanalyzed code portion 610. If unanalyzed code portion 610 is not empty, this instructs context selector 608 to select a next context for iteration on unanalyzed code portion 610. According to embodiments, context selector 608 can select a next context in any manner, including as described above with respect to step 502 (FIG. 5), or in any other manner. As shown in FIG. 6, context selector 608 outputs the selected next context as selected next context 614. IA function executer 604 receives selected next context 614, and uses the received selected next context as the selected current context for the next iteration of step 704. Operation proceeds from step 712 to step 704.

### III. Example Mobile and Stationary Device Embodiments

Computing device(s) 118, development system 100, source code editor 102, compiler 104, debugger tool 106, multi-context assistance iterator 108, multi-context assistance iterator 602, IA function executer 604, code tracker 606, context selector 608, flowchart 200, flowchart 300, flowchart 400, flowchart 500, and flowchart 700 may be implemented in hardware, or hardware combined with software and/or firmware. For example, development system 100, source code editor 102, compiler 104, debugger tool 106, multi-context assistance iterator 108, multi-context assistance iterator 602, IA function executer 604, code tracker 606, context selector 608, flowchart 200, flowchart 300, flowchart 400, flowchart 500, and/or flowchart 700 may be implemented as computer program code/instructions configured to be executed in one or more processors and stored in a computer readable storage medium. Alternatively, computing device(s) 118, development system 100, source code editor 102, compiler 104, debugger tool 106, multi-context assistance iterator 108, multi-context assistance iterator 602, IA function executer 604, code tracker 606, context selector 608, flowchart 200, flowchart 300, flowchart 400, flowchart 500, and/or flowchart 700 may be implemented as hardware logic/electrical circuitry.

For instance, in an embodiment, one or more, in any combination, of development system 100, source code editor 102, compiler 104, debugger tool 106, multi-context assistance iterator 108, multi-context assistance iterator 602, IA function executer 604, code tracker 606, context selector 608, flowchart 200, flowchart 300, flowchart 400, flowchart 500, and/or flowchart 700 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

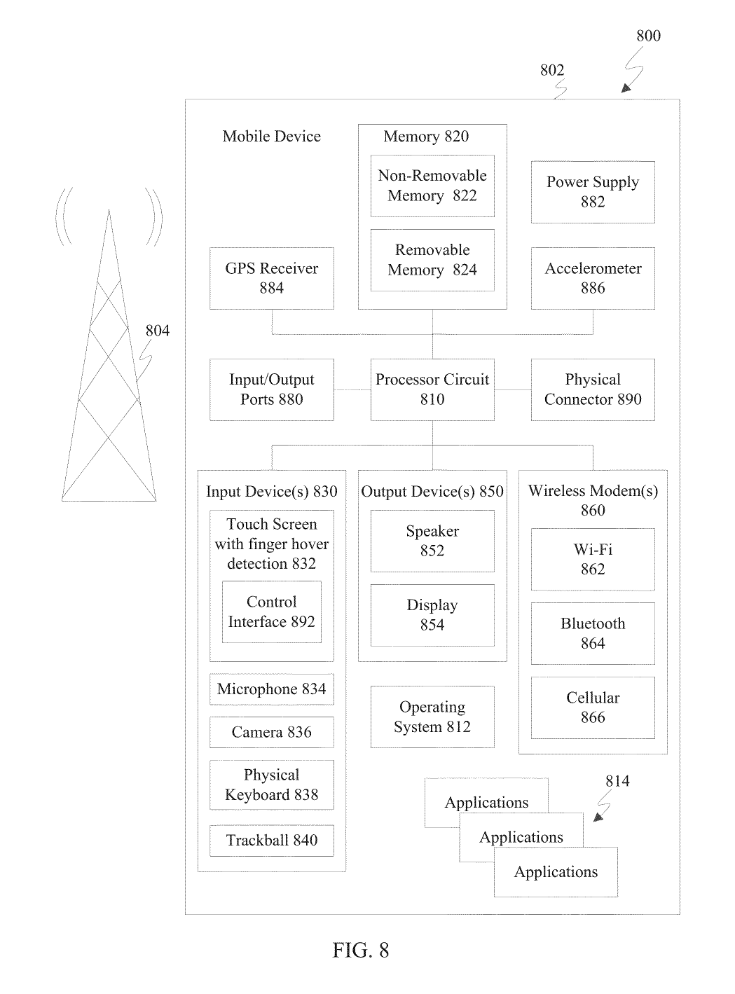

FIG. 8 shows a block diagram of an exemplary mobile device 800 including a variety of optional hardware and software components, shown generally as components 802. For instance, components 802 of mobile device 800 are examples of components that may be included in computing device(s) 118 (FIG. 1) in mobile device embodiments. Any number and combination of the features/elements of components 802 may be included in a mobile device embodiment, as well as additional and/or alternative features/elements, as would be known to persons skilled in the relevant art(s). It is noted that any of components 802 can communicate with any other of components 802, although not all connections are shown, for ease of illustration. Mobile device 800 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 804, such as a cellular or satellite network, or with a local area or wide area network.

The illustrated mobile device 800 can include a controller or processor referred to as processor circuit 810 for performing such tasks as signal coding, image processing, data processing, input/output processing, power control, and/or other functions. Processor circuit 810 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 810 may execute program code stored in a computer readable medium, such as program code of one or more applications 814, operating system 812, any program code stored in memory 820, etc. Operating system 812 can control the allocation and usage of the components 802 and support for one or more application programs 814 (a.k.a. applications, “apps”, etc.). Application programs 814 can include common mobile computing applications (e.g., email applications, calendars, contact managers, web browsers, messaging applications) and any other computing applications (e.g., word processing applications, mapping applications, media player applications).

As illustrated, mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. Memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 820. These programs include operating system 812, one or more application programs 814, and other program modules and program data. Examples of such application programs or program modules may include, for example, computer program logic (e.g., computer program code or instructions) for implementing development system 100, source code editor 102, compiler 104, debugger tool 106, multi-context assistance iterator 108, multi-context assistance iterator 602, IA function executer 604, code tracker 606, context selector 608, flowchart 200, flowchart 300, flowchart 400, flowchart 500, and/or flowchart 700 (including any suitable step of flowcharts 200, 300, 400, 500, and 700), and/or further embodiments described herein.

Mobile device 800 can support one or more input devices 830, such as a touch screen 832, microphone 834, camera 836, physical keyboard 838 and/or trackball 840 and one or more output devices 850, such as a speaker 852 and a display 854. Touch screens, such as touch screen 832, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 832 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

The touch screen 832 is shown to include a control interface 892 for illustrative purposes. The control interface 892 is configured to control content associated with a virtual element that is displayed on the touch screen 832. In an example embodiment, the control interface 892 is configured to control content that is provided by one or more of applications 814. For instance, when a user of the mobile device 800 utilizes an application, the control interface 892 may be presented to the user on touch screen 832 to enable the user to access controls that control such content. Presentation of the control interface 892 may be based on (e.g., triggered by) detection of a motion within a designated distance from the touch screen 832 or absence of such motion. Example embodiments for causing a control interface (e.g., control interface 892) to be presented on a touch screen (e.g., touch screen 832) based on a motion or absence thereof are described in greater detail below.

Other possible output devices (not shown) can include piezoelectric or other haptic output devices. Some devices can serve more than one input/output function. For example, touch screen 832 and display 854 can be combined in a single input/output device. The input devices 830 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice control interface that allows a user to operate the device 800 via voice commands. Further, device 800 can comprise input devices and software that allows for user interaction via a user's spatial gestures, such as detecting and interpreting gestures to provide input to a gaming application.

Wireless modem(s) 860 can be coupled to antenna(s) (not shown) and can support two-way communications between processor circuit 810 and external devices, as is well understood in the art. The modem(s) 860 are shown generically and can include a cellular modem 866 for communicating with the mobile communication network 804 and/or other radio-based modems (e.g., Bluetooth 864 and/or Wi-Fi 862). Cellular modem 866 may be configured to enable phone calls (and optionally transmit data) according to any suitable communication standard or technology, such as GSM, 3G, 4G, 5G, etc. At least one of the wireless modem(s) 860 is typically configured for communication with one or more cellular networks, such as a GSM network for data and voice communications within a single cellular network, between cellular networks, or between the mobile device and a public switched telephone network (PSTN).

Mobile device 800 can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can be not present and other components can be additionally present as would be recognized by one skilled in the art.

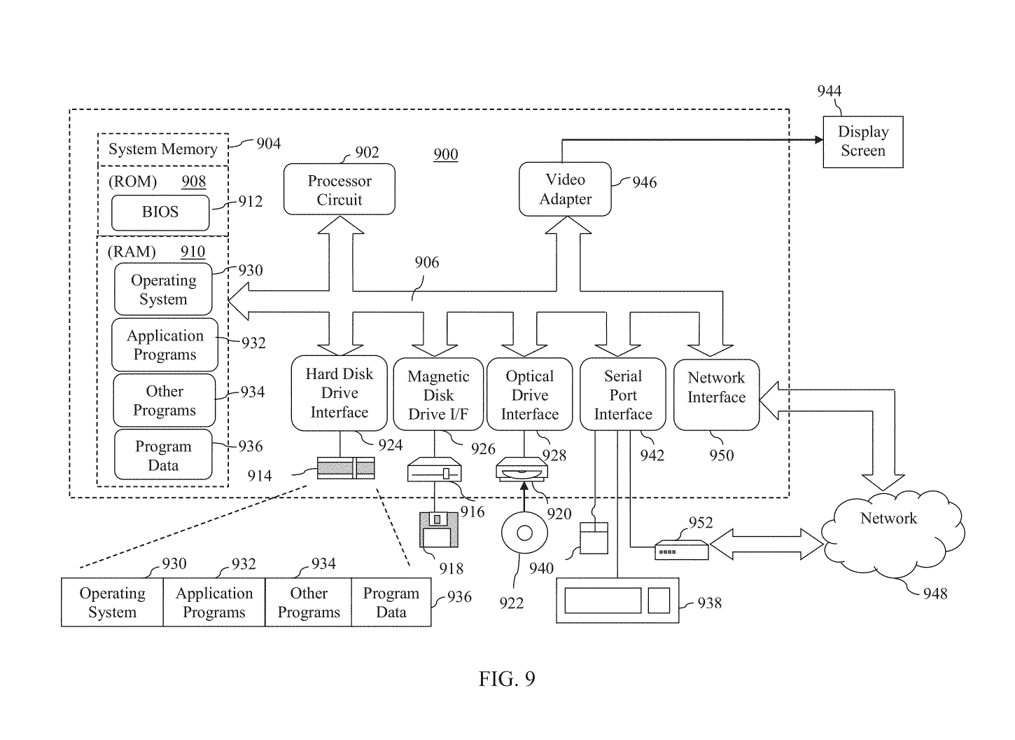

Furthermore, FIG. 9 depicts an exemplary implementation of a computing device 900 in which embodiments may be implemented. For example, computing device(s) 118 (FIG. 1) may be implemented in one or more computing devices similar to computing device 900 in stationary computer embodiments, including one or more features of computing device 900 and/or alternative features. The description of computing device 900 provided herein is provided for purposes of illustration, and is not intended to be limiting. Embodiments may be implemented in further types of computer systems, as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing development system 100, source code editor 102, compiler 104, debugger tool 106, multi-context assistance iterator 108, multi-context assistance iterator 602, IA function executer 604, code tracker 606, context selector 608, flowchart 200, flowchart 300, flowchart 400, flowchart 500, and/or flowchart 700 (including any suitable step of flowcharts 200, 300, 400, 500, and 700), and/or further embodiments described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to generally refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media (including memory 820 of FIG. 8). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

In one embodiment, a method in a code development tool is provided, comprising: receiving a request to perform an intelligent assistance function on a program code in an active context of a plurality of contexts associated with the program code; in response to receiving the request, performing the intelligent assistance function on the program code in the active context to determine code knowledge regarding the program code for the active context, determining a first portion of the program code for which the intelligent assistance function is able to be performed for the active context and a second portion of the program code for which the intelligent assistance function is not able to be performed for the active context, and performing the intelligent assistance function on the second portion of the program code in at least one additional context of the plurality of contexts to determine code knowledge regarding the program code for the at least one additional context; and responding to the request with results of performing the intelligent assistance function on the program code, the results covering all contexts of the plurality of contexts.

In an embodiment, the performing the intelligent assistance function on the second portion of the program code in at least one additional context of the plurality of contexts to determine code knowledge regarding the program code for the at least one additional context comprises: performing the intelligent assistance function on the program code in a second context of the plurality of contexts to determine code knowledge regarding the program code for the second context, determining a third portion of the second portion of the program code for which the intelligent assistance function is able to be performed for the second context and a fourth portion of the second portion of the program code for which the intelligent assistance function is not able to be performed for the active context, and performing the intelligent assistance function on the fourth portion of the program code in at least a third context of the plurality of contexts to determine code knowledge regarding the program code for at least the third context.

In an embodiment, the plurality of contexts includes a debug context and a release context.

In an embodiment, the plurality of contexts includes a first operating system context and a second operating system context.

In an embodiment, the plurality of contexts includes a first instruction set architecture context and a second instruction set architecture context.

In an embodiment, the determining a first portion of the program code for which the intelligent assistance function is able to be performed for the active context and a second portion of the program code for which the intelligent assistance function is not able to be performed for the active context comprises: detecting one or more first code portions in the program code marked with a conditional compilation indicator for the active context or not marked with a conditional compilation indicator; including the detected one or more first code portions in the determined first portion of the program code; detecting one or more second code portions in the program code marked with a conditional compilation indicator for a context other than the active context; and including the detected one or more second code portions in the determined second portion of the program code.

In an embodiment, the intelligent assistance function is not performed for all contexts of the plurality of contexts to generate the results covering all contexts of the plurality of contexts.

In another embodiment, a system comprises a user interface and a multi-context assistance iterator. The user interface is configured to receive a request to perform an intelligent assistance function on a program code, and to provide a response to the request that includes results of performing the intelligent assistance function on the program code, the results covering all contexts of a plurality of contexts associated with the program code. The multi-context assistance iterator is configured to iteratively perform the intelligent assistance function on the program code in response to the request to generate the results. The multi-context assistance iterator includes: a function executer configured to perform the intelligent assistance function on the program code for a current selected context of the plurality of contexts to determine code knowledge regarding the program code for the current selected context, the determined code knowledge included in the results, a code tracker configured to track an unanalyzed portion of the program code on which the intelligent assistance function is not able to be performed for the selected current context and any prior selected contexts, and a context selector configured to select a next context of the plurality of contexts to be the next selected current context to cause the function executer to perform the intelligent assistance function on the unanalyzed portion of the program code to determine code knowledge regarding the program code for the next selected next context.

In an embodiment, the function executer is configured to perform the intelligent assistance function on the program code initially in an active context of the plurality of contexts to determine code knowledge regarding the program code for the active context; the code tracker is configured to track a first unanalyzed portion of the program code for which the intelligent assistance function is unable to be performed for the active context; and the context selector is configured to select a next context of the plurality of contexts to be the next selected current context after the active context to cause the function executer to perform the intelligent assistance function on the first unanalyzed portion of the program code to determine code knowledge regarding the program code for the next selected next context.

In an embodiment, the plurality of contexts includes a debug context and a release context.

In an embodiment, the plurality of contexts includes a first operating system context and a second operating system context.

In an embodiment, the plurality of contexts includes a first instruction set architecture context and a second instruction set architecture context.

In an embodiment, the function executer is configured to detect one or more unanalyzed code portions in the program code marked with a conditional compilation indicator for a context other than the current selected context; and the code tracker is configured to include the detected one or more unanalyzed code portions in the unanalyzed portion of the program code.

In an embodiment, the intelligent assistance function is not performed by the function executer for all contexts of the plurality of contexts to generate the results covering all contexts of the plurality of contexts.

In another embodiment, a computer-readable storage medium comprises computer-executable instructions that, when executed by a processor, perform a method comprising: receiving a request to perform an intelligent assistance function on a program code in an active context of a plurality of contexts associated with the program code; in response to receiving the request, performing the intelligent assistance function on the program code in the active context to determine code knowledge regarding the program code for the active context, determining a first portion of the program code for which the intelligent assistance function is able to be performed for the active context and a second portion of the program code for which the intelligent assistance function is not able to be performed for the active context, and performing the intelligent assistance function on the second portion of the program code in at least one additional context of the plurality of contexts to determine code knowledge regarding the program code for the at least one additional context; and responding to the request with results of performing the intelligent assistance function on the program code, the results covering all contexts of the plurality of contexts.

In an embodiment, the performing the intelligent assistance function on the second portion of the program code in at least one additional context of the plurality of contexts to determine code knowledge regarding the program code for the at least one additional context comprises: performing the intelligent assistance function on the program code in a second context of the plurality of contexts to determine code knowledge regarding the program code for the second context, determining a third portion of the second portion of the program code for which the intelligent assistance function is able to be performed for the second context and a fourth portion of the second portion of the program code for which the intelligent assistance function is not able to be performed for the active context, and performing the intelligent assistance function on the fourth portion of the program code in at least a third context of the plurality of contexts to determine code knowledge regarding the program code for at least the third context.

In an embodiment, the plurality of contexts includes a debug context and a release context.

In an embodiment, the plurality of contexts includes a first operating system context and a second operating system context.

In an embodiment, the plurality of contexts includes a first instruction set architecture context and a second instruction set architecture context.

In an embodiment, the determining a first portion of the program code for which the intelligent assistance function is able to be performed for the active context and a second portion of the program code for which the intelligent assistance function is not able to be performed for the active context comprises: detecting one or more first code portions in the program code marked with a conditional compilation indicator for the active context or not marked with a conditional compilation indicator; including the detected one or more first code portions in the determined first portion of the program code; detecting one or more second code portions in the program code marked with a conditional compilation indicator for a context other than the active context; and including the detected one or more second code portions in the determined second portion of the program code.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a code development tool, comprising:
receiving a request to perform an intelligent assistance function on a program code in an active context of a plurality of contexts associated with the program code;
in response to receiving the request
performing the intelligent assistance function on the program code in the active context to determine code knowledge regarding the program code for the active context,
determining a first portion of the program code for which the intelligent assistance function is able to be performed for the active context and a second portion of the program code for which the intelligent assistance function is not able to be performed for the active context, and
performing the intelligent assistance function on the second portion of the program code in at least one additional context of the plurality of contexts to determine code knowledge regarding the program code for the at least one additional context; and
responding to the request with results of performing the intelligent assistance function on the program code, the results covering all contexts of the plurality of contexts.

2. The method of claim 1, wherein said performing the intelligent assistance function on the second portion of the program code in at least one additional context of the plurality of contexts to determine code knowledge regarding the program code for the at least one additional context comprises:
performing the intelligent assistance function on the program code in a second context of the plurality of contexts to determine code knowledge regarding the program code for the second context,
determining a third portion of the second portion of the program code for which the intelligent assistance function is able to be performed for the second context and a fourth portion of the second portion of the program code for which the intelligent assistance function is not able to be performed for the active context, and
performing the intelligent assistance function on the fourth portion of the program code in at least a third context of the plurality of contexts to determine code knowledge regarding the program code for at least the third context.

3. The method of claim 1, wherein the plurality of contexts includes a debug context and a release context.

4. The method of claim 1, wherein the plurality of contexts includes a first operating system context and a second operating system context.

5. The method of claim 1, wherein the plurality of contexts includes a first instruction set architecture context and a second instruction set architecture context.

6. The method of claim 1, wherein said determining a first portion of the program code for which the intelligent assistance function is able to be performed for the active context and a second portion of the program code for which the intelligent assistance function is not able to be performed for the active context comprises:
detecting one or more first code portions in the program code marked with a conditional compilation indicator for the active context or not marked with a conditional compilation indicator;
including the detected one or more first code portions in the determined first portion of the program code;
detecting one or more second code portions in the program code marked with a conditional compilation indicator for a context other than the active context; and
including the detected one or more second code portions in the determined second portion of the program code.

7. The method of claim 1, wherein the intelligent assistance function is not performed for all contexts of the plurality of contexts to generate the results covering all contexts of the plurality of contexts.

8. A system, comprising:
a user interface configured to receive a request to perform an intelligent assistance function on a program code, and to provide a response to the request that includes results of performing the intelligent assistance function on the program code, the results covering all contexts of a plurality of contexts associated with the program code; and
a multi-context assistance iterator configured to iteratively perform the intelligent assistance function on the program code in response to the request to generate the results, the multi-context assistance iterator including
a function executer configured to perform the intelligent assistance function on the program code for a current selected context of the plurality of contexts to determine code knowledge regarding the program code for the current selected context, the determined code knowledge included in the results,
a code tracker configured to track an unanalyzed portion of the program code on which the intelligent assistance function is not able to be performed for the selected current context and any prior selected contexts, and
a context selector configured to select a next context of the plurality of contexts to be the next selected current context to cause the function executer to perform the intelligent assistance function on the unanalyzed portion of the program code to determine code knowledge regarding the program code for the next selected next context.

9. The system of claim 8, wherein the function executer is configured to perform the intelligent assistance function on the program code initially in an active context of the plurality of contexts to determine code knowledge regarding the program code for the active context;
the code tracker is configured to track a first unanalyzed portion of the program code for which the intelligent assistance function is unable to be performed for the active context; and
the context selector is configured to select a next context of the plurality of contexts to be the next selected current context after the active context to cause the function executer to perform the intelligent assistance function on the first unanalyzed portion of the program code to determine code knowledge regarding the program code for the next selected next context.

10. The system of claim 8, wherein the plurality of contexts includes a debug context and a release context.

11. The system of claim 8, wherein the plurality of contexts includes a first operating system context and a second operating system context.

12. The system of claim 8, wherein the plurality of contexts includes a first instruction set architecture context and a second instruction set architecture context.

13. The system of claim 8, wherein the function executer is configured to detect one or more unanalyzed code portions in the program code marked with a conditional compilation indicator for a context other than the current selected context; and
the function executer is configured to accumulate the detected one or more unanalyzed code portions in the unanalyzed portion of the program code.

14. The system of claim 8, wherein the intelligent assistance function is not performed by the function executer for all contexts of the plurality of contexts to generate the results covering all contexts of the plurality of contexts.

15. A computer-readable storage medium comprising computer-executable instructions that, when executed by a processor, perform a method comprising:
receiving a request to perform an intelligent assistance function on a program code in an active context of a plurality of contexts associated with the program code;
in response to receiving the request
performing the intelligent assistance function on the program code in the active context to determine code knowledge regarding the program code for the active context,
determining a first portion of the program code for which the intelligent assistance function is able to be performed for the active context and a second portion of the program code for which the intelligent assistance function is not able to be performed for the active context, and
performing the intelligent assistance function on the second portion of the program code in at least one additional context of the plurality of contexts to determine code knowledge regarding the program code for the at least one additional context; and
responding to the request with results of performing the intelligent assistance function on the program code, the results covering all contexts of the plurality of contexts.

16. The computer-readable storage medium of claim 15, wherein said performing the intelligent assistance function on the second portion of the program code in at least one additional context of the plurality of contexts to determine code knowledge regarding the program code for the at least one additional context comprises:
performing the intelligent assistance function on the program code in a second context of the plurality of contexts to determine code knowledge regarding the program code for the second context,
determining a third portion of the second portion of the program code for which the intelligent assistance function is able to be performed for the second context and a fourth portion of the second portion of the program code for which the intelligent assistance function is not able to be performed for the active context, and
performing the intelligent assistance function on the fourth portion of the program code in at least a third context of the plurality of contexts to determine code knowledge regarding the program code for at least the third context.

17. The computer-readable storage medium of claim 15, wherein the plurality of contexts includes a debug context and a release context.

18. The computer-readable storage medium of claim 15, wherein the plurality of contexts includes a first operating system context and a second operating system context.

19. The computer-readable storage medium of claim 15, wherein the plurality of contexts includes a first instruction set architecture context and a second instruction set architecture context.

20. The computer-readable storage medium of claim 15, wherein said determining a first portion of the program code for which the intelligent assistance function is able to be performed for the active context and a second portion of the program code for which the intelligent assistance function is not able to be performed for the active context comprises:
detecting one or more first code portions in the program code marked with a conditional compilation indicator for the active context or not marked with a conditional compilation indicator;
including the detected one or more first code portions in the determined first portion of the program code;
detecting one or more second code portions in the program code marked with a conditional compilation indicator for a context other than the active context; and
including the detected one or more second code portions in the determined second portion of the program code.
